(19) United States
(12) Patent Application Publication
(10) Pub. No.: US 2004/0135686 A1
(43) Pub. Date: Jul. 15, 2004

(54) Remote audio visual home monitor

(76) Inventor: Dionna O. Parker, Newport News, VA (US)

Correspondence Address: DIONNA O. PARKER, 1021-31ST ST., NEWPORT NEWS, VA, 23605, US

(21) Appl. No.: 10/693,385

(22) Filed: Oct. 24, 2003

Related U.S. Application Data
(60) Provisional application No. 60/423,425, filed on Nov. 4, 2002.

(51) Int. Cl. H04M 1/66; H04M 1/68; H04M 3/16; G08B 21/00

(52) U.S. Cl. 340/540; 455/410

(57) ABSTRACT

An apparatus for first hand home/property surveillance includes an audio visual remote/phone. The audio visual remote/phone includes a computer (located inside said property) which works inconjunction with a motion sensor and/or buzzer which activates the mounted camera to start recording picture data and at the same time alerts and sends a signal to dial the audio visual remote/phone and a microphone/speaker (intercom) is on location thus having first hand audio and visual surveillance with the capability to converse.

### BACKGROUND OF THE INVENTION

1. Field of the Invention

The present invention relates to surveillance of home/personal property but not by way of limitation to a method and apparatus capable of audio and visual communication surveillance when emerged off premises.

2. Description of the Related Art

To date home/property security monitors are set up for surveillance in and around the property; prospectively once the owner or person(s) has emerged off the premises one is without awareness and first-hand surveillance of said property. Accordingly there is a need for first hand surveillance with audio and visual communication when emerged off premises local or long distance as technology advances.

### BRIEF SUMMARY OF THE INVENTION

In accordance with the present invention an apparatus for the capability of first-hand surveillance with audio and visual communication includes a computer (or alternate connection/recording device) located inside said property to work in conjunction with the motion sensor and/or buzzer which in tell will send a direct signal to dial the audio visual remote or phone (located with person) also at this time the camera(s) mounted on premises near designated entrances is activated to record picture data stored in computer (or alternate recording/memory device). A microphone/speaker box is also on premises near main entrances for audio conversion.

An apparatus for audio visual capabilities of first-hand surveillance will aid to deter burglaries, home invasions, vandalism, uninvited guest and proficient response with local 911 service. In the event of the destruction of the camera monitor(s), motion has already been detected sending notification to respective person(s) of improper activity on said property.

An apparatus for audio visual capabilities of first-hand surveillance is timely when expecting guest, package delivery, welcomed unexpected guest and other situations that may apply.

An apparatus for audio visual capabilities of first-hand surveillance assures awareness of said property in any event when emerged off premises.

### BRIEF DESCRIPTION OF DRAWING

FIG. 1

The fabrication of first hand surveillance of said property are described, by way of example only, with reference to the drawings.

### DETAILED DESCRIPTION OF THE INVENTION

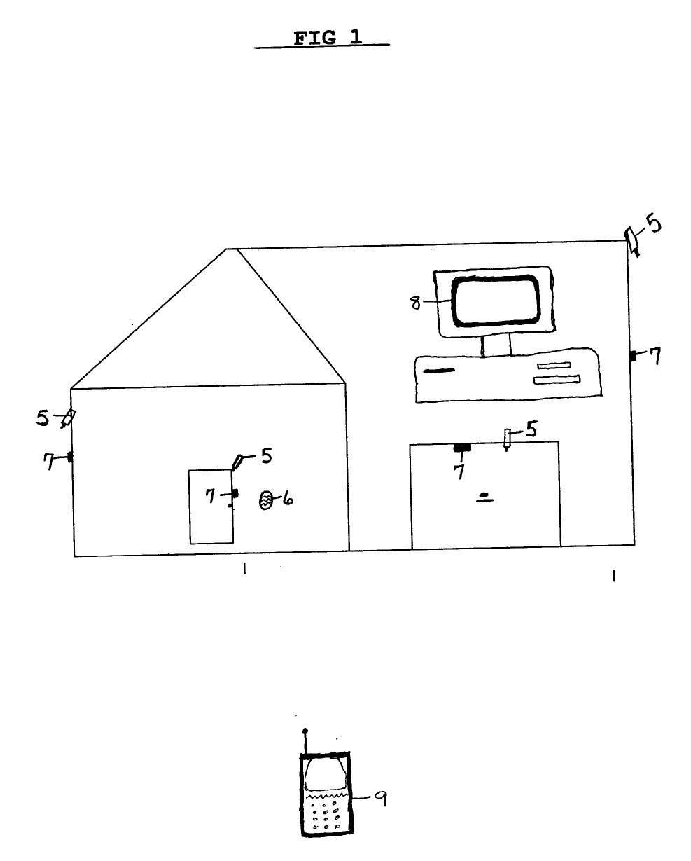

As illustrated in FIG. 1, activity occurs and the integrated motion sensor/buzzer 7 activates the camera monitors 5 and computer 8. The computer 8 automatically dials and alerts the audio visual remote/phone 9 transmitting streaming audio and visual from the camera monitors 5 to the remote/phone 9. First hand surveillance with audio visual communication is available and the visitor(s) is able to converse by way of using the microphone speaker 6. Camera monitors 5 sends picture data to be recorded and stored in computer 8.

What is claimed is:

1. An apparatus for first hand surveillance with the capability of audio and visual communication specifically when emerged off said property local or long distance as technology advances.

2. The apparatus of first hand surveillance according to claim 1 wherein includes the motion sensor(s) and or buzzer(s).

3. The apparatus of first hand surveillance according to claim 2 wherein is a reactor to activity or visitor(s).

4. The apparatus of first hand surveillance according to claim 1 wherein also includes camera monitor(s).

5. The apparatus of first hand surveillance according to claim 4 wherein enables surveillance with the ability to record the said property.

6. The apparatus of first hand surveillance according to claim 1 wherein also includes microphone(s) and speakers(s).

7. The apparatus of first hand surveillance according to claim 6 wherein enables audio conversion.

8. The apparatus of first hand surveillance according to claim 1 wherein also includes a computer inside said property.

9. The apparatus of first hand surveillance according to claim 8 wherein works inconjuction with the motion sensor(s) and or buzzer(s).

10. The apparatus of first hand surveillance according to claim 8 wherein stores data.

11. The apparatus of first hand surveillance according to claim 1 wherein includes an audiovisual remote or phone.

12. The apparatus of first hand surveillance according to claim 1 wherein for notification of activity on said property.

13. The apparatus of first hand surveillance according to claim 11 wherein transmits audio and video communication of individuals on said property.

14. The apparatus of first hand surveillance according to claim 2 wherein is set at the capacity of human activation.

15. An apparatus for first hand surveillance with the capability of audio and visual transmission when emerged off said property is fabricated by a method comprising the steps of:
(a) when said property is accessed, the technology integrated motion sensor and or buzzer, computer and camera monitors are solidarity activated sending a direct signal to the remote phone located with property owner or user;
(b) the signal transmitted is visual and audio focusing on the targeted area(s) on said property;
(c) camera monitors capture picture data and sends recorded data to the computer to be stored;
(d) with the audio visual remote phone and microphone speakers on premises first hand surveillance with conversion is available.

16. The apparatus of first hand surveillance audio visual remote/phone may have additional aptness fabricated by a method comprising to do the following:
(a) notification options: lights up, vibrates, and/or audio tones;
(b) audio control for speaker and microphone;
(c) volume control;
(d) light/dark control;
(e) zoom in/out;
(f) view from one camera to another or split screen;
(g) able to page/contact compatible remotes for viewing and conversion;
(h) low battery notification;
(i) capable to start specific vehicles, lock and unlock door;
(j) capable to raise and lower garage doors;
(k) lock and unlock specific property doors;
(l) deactivation in case of lost or theft;
(m) page notification if misplace;
(n) recorder to ask the unfamiliar to exit property and or authorities being notified;
(o) rechargeable adapters: wall sockets and vehicle compatible;
(p) for pet owners additional timed set sensors for pet doors.

17. An apparatus for first hand surveillance using an alternate connection capability and recording devices:
(a) if said property is without a computer then the camera(s), sensor(s), doorbell, and intercom can be linked directly to a phone line, wireless network or satellite for connection capabilities;
(b) alternate recording devices may be used such as VCR, DVD, CD burners and other recording devices as technology advances.
